(19) United States
(12) Patent Application Publication
(10) Pub. No.: US 2009/0135807 A1
(43) Pub. Date: May 28, 2009

(54) PERSISTENT SCHEDULING OF HARQ RETRANSMISSIONS

(76) Inventors: Shweta Shrivastava, Beaverton, OR (US); Rath Vannithamby, Portland, OR (US)

Correspondence Address: COOL PATENT, P.C.;c/o CPA Global, P.O. BOX 52050, MINNEAPOLIS, MN, 55402, US

(21) Appl. No.: 11/945,596

(22) Filed: Nov. 27, 2007

(51) Int. Cl. H04L 12/66

(52) U.S. Cl. 370/352

(57) ABSTRACT

Briefly, in accordance with one or more embodiments, HARQ retransmissions may be persistently scheduled so as to efficiently allocate network without requiring the HARQ retransmissions to be scheduled for every frame or nearly every frame. Furthermore, grouping of users may occur using a bitmap for the HARQ retransmissions using the same bitmap as used for scheduling of the original packet transmission or using a separate bitmap for the HARQ retransmissions. In the event one or more scheduled HARQ retransmissions are not needed, the base station is capable of reallocating the previously scheduled resources.

### BACKGROUND

In wireless networks using technologies such as an Institute of Electrical and Electronics Engineers (IEEE) IEEE 802.16 standard and/or a Third Generation Partnership Project (3GPP) standard, the scheduling of resources may be centralized and dynamic, and may be performed by the base station (BS). The scheduling information is conveyed by the base station to one or more mobile stations (MS) in the form of control information that is referred to as a MAP. The size of the MAP is proportional to the number of mobile stations scheduled in a given frame. If the packets to be scheduled are smaller in size, for example in Voice over Internet Protocol (VoIP) applications, then a relatively larger number of users can be scheduled in a given frame, resulting in a larger MAP overhead. Persistent scheduling is a mechanism that may be capable of reducing such a larger MAP overhead. In persistent scheduling, instead of refreshing resource allocation for a given mobile station in every frame, the mobile station is scheduled persistently for a multiple number of frames, for example for N frames. The scheduling or MAP information may be conveyed only in the first frame and then skipped in subsequent N-1 frames, thereby saving overhead. Typically, a mobile station will not be persistently allocated in every frame, but for a predetermined period of time p_{f}.

Persistently scheduling packet transmissions for VoIP applications can save considerable overhead. However, it is not clear how to schedule hybrid automatic repeat-request (HARQ) retransmissions when the first transmissions are persistently scheduled. If HARQ retransmissions are not persistently scheduled, then there will be considerable overhead in scheduling them; a significant gain may not be seen from persistently scheduling a first transmission only. Persistently scheduling HARQ retransmissions may save MAP overhead, but resources may be wasted if retransmissions are not needed for a particular packet, since it is not possible to determine in advance the number of retransmissions for each packet.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram of a wireless network in which HARQ retransmissions may be persistently scheduled in accordance with one or more embodiments;

FIG. 2 is a diagram showing the grouping of mobile stations using a bitmap for persistent scheduling in accordance with one or more embodiments;

FIG. 3 is a diagram showing an example of persistent allocation of HARQ retransmissions with respect to first transmissions in accordance with one or more embodiments;

FIG. 4 is a diagram showing the use of allocated resources for different packets where the ACK delay is less than two frames in accordance with one or more embodiments; and

FIG. 5 is a diagram showing the use of allocated resources for different packets where the ACK delay less than four frames in accordance with one or more embodiments;

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

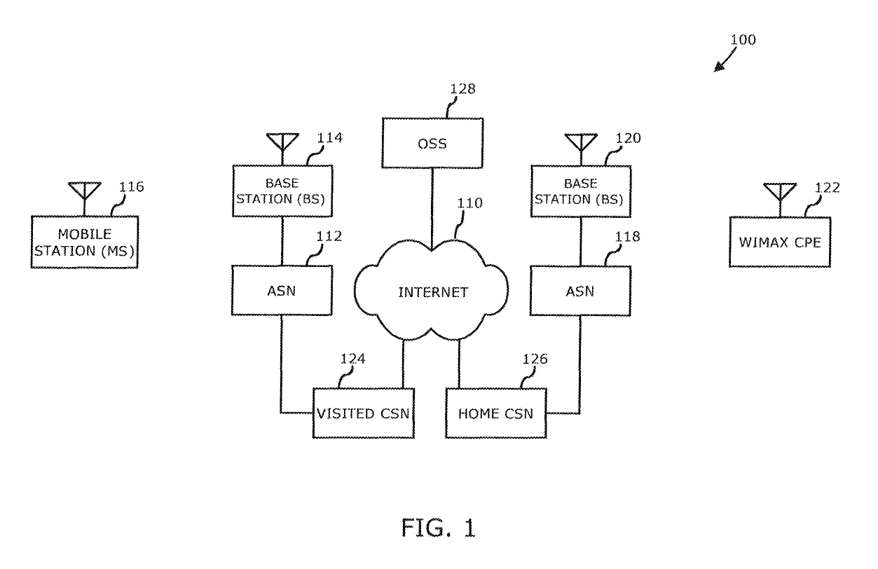

Referring now to FIG. 1, a block diagram of a wireless network in which HARQ retransmissions may be persistently scheduled in accordance with one or more embodiments will be discussed. As shown in FIG. 1, network 100 may be an internet protocol (IP) type network comprising an internet 110 type network or the like that is capable of supporting mobile wireless access and/or fixed wireless access to internet 110. In one or more embodiments, network 100 may be in compliance with a Worldwide Interoperability for Microwave Access (WiMAX) standard or future generations of WiMAX, and in one particular embodiment may be in compliance with an Institute for Electrical and Electronics Engineers 802.16e standard (IEEE 802.16e). In one or more alternative embodiments network 100 may be in compliance with a Third Generation Partnership Project Long Term Evolution (3GPP LTE) or a 3GPP2 Air Interface Evolution (3GPP2 AIE) standard. In general, network 100 may comprise any type of orthogonal frequency division multiple access (OFDMA) based wireless network, and the scope of the claimed subject matter is not limited in these respects. As an example of mobile wireless access, access service network (ASN) 112 is capable of coupling with base station (BS) 114 to provide wireless communication between mobile station (SS) 116 and internet 110. Mobile station 116 may comprise a mobile type device or information handling system capable of wirelessly communicating via network 100, for example a notebook type computer, a cellular telephone, a personal digital assistant, or the like. ASN 112 may implement profiles that are capable of defining the mapping of network functions to one or more physical entities on network 100. Base station 114 may comprise radio equipment to provide radio-frequency (RF) communication with mobile station 116, and may comprise, for example, the physical layer (PHY) and media access control (MAC) layer equipment in compliance with an IEEE 802.16e type standard. Base station 114 may further comprise an IP backplane to couple to internet 110 via ASN 112, although the scope of the claimed subject matter is not limited in these respects.

Network 100 may further comprise a visited connectivity service network (CSN) 124 capable of providing one or more network functions including but not limited to proxy and/or relay type functions, for example authentication, authorization and accounting (AAA) functions, dynamic host configuration protocol (DHCP) functions, or domain name service controls or the like, domain gateways such as public switched telephone network (PSTN) gateways or voice over internet protocol (VoIP) gateways, and/or internet protocol (IP) type server functions, or the like. However, these are merely example of the types of functions that are capable of being provided by visited CSN or home CSN 126, and the scope of the claimed subject matter is not limited in these respects. Visited CSN 124 may be referred to as a visited CSN in the case for example where visited CSN 124 is not part of the regular service provider of mobile station 116, for example where mobile station 116 is roaming away from its home CSN such as home CSN 126, or for example where network 100 is part of the regular service provider of mobile station but where network 100 may be in another location or state that is not the main or home location of mobile station 116. In a fixed wireless arrangement, WiMAX type customer premises equipment (CPE) 122 may be located in a home or business to provide home or business customer broadband access to internet 110 via base station 120, ASN 118, and home CSN 126 in a manner similar to access by mobile station 116 via base station 114, ASN 112, and visited CSN 124, a difference being that WiMAX CPE 122 is generally disposed in a stationary location, although it may be moved to different locations as needed, whereas mobile station may be utilized at one or more locations if mobile station 116 is within range of base station 114 for example. In accordance with one or more embodiments, operation support system (OSS) 128 may be part of network 100 to provide management functions for network 100 and to provide interfaces between functional entities of network 100. Network 100 of FIG. 1 is merely one type of wireless network showing a certain number of the components of network 100, however the scope of the claimed subject matter is not limited in these respects.

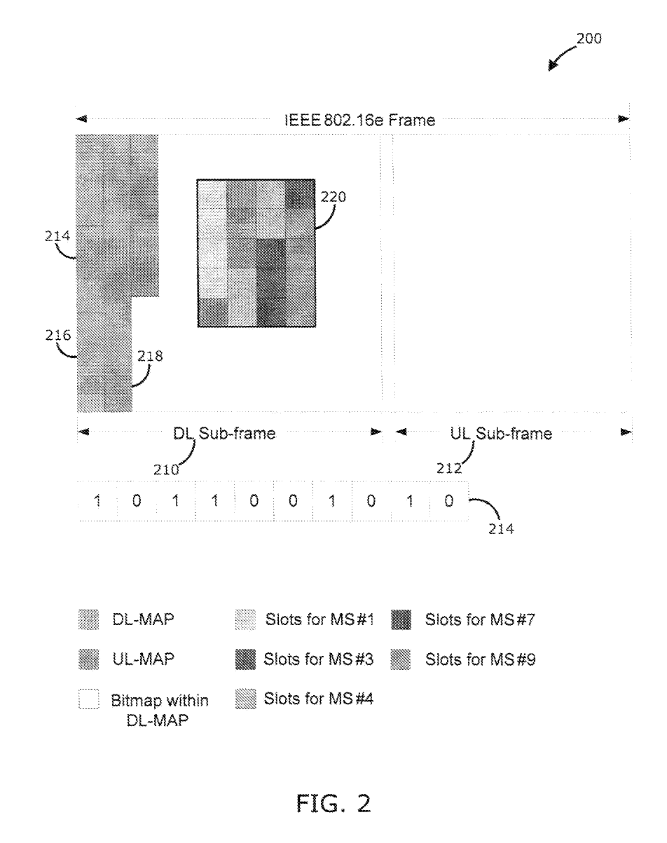

Referring now to FIG. 2, a diagram showing the grouping of mobile stations using a bitmap for persistent scheduling in accordance with one or more embodiments will be discussed. In one or more embodiments, frame 200 may comprise a downlink (DL) sub-frame 210 and an uplink (UL) sub-frame 212. A downlink map 216 and/or and uplink map 218 may be transmitted from base station 120 to the mobile stations 116 in the downlink sub-frame 210. In one or more embodiments, frame 200 may be in compliance with an IEEE 802.16e standard or the like, although the scope of the claimed subject matter is not limited in this respect. When persistent scheduling of individual mobile stations 116, a mobile station 116 may go into silence. In such an event, persistent allocation for that mobile station 116 should be canceled, and the resources for the silent mobile station 116 may be reallocated to another mobile station 116 who needs a same or similar resource size as the original mobile station 116. However, such reallocation may be difficult to achieve, resulting in resource holes in the frame. Grouping with bitmap 214 is a mechanism to efficiently perform persistent scheduling by avoiding resource holes in the frame 200 that can arise due to some users going into silence or needing new allocation because of changes in modulation and/or coding scheme (MCS). In the case of grouping, multiple users may be grouped together based on a common parameter. Typically, the common parameter is MCS since such a grouping may ensure the same number of slots for packets of all or nearly all the mobile stations 116 in the group, for example for applications such as VoIP in which constant size packets may be generated. In such an arrangement, the group of mobile stations 116 may be assigned resources in the frame 200 as a whole. Individual mobile stations 116 belonging to the group are assigned slots within the resources of the group.

For example, a first mobile station 116, MS 1, may be assigned four slots starting at slot 1, a second mobile station 116, MS 2, may be assigned four slots starting at slot 5, and so on. In the event some mobile stations 116 go into a silence period, the resources of remaining mobile stations 116 may need to be moved. In order to accommodate this reallocation, a bitmap 214 is used. The bitmap 214 may be sent as part of the MAP information in every frame, or nearly every frame. Size of bitmap 214 may be equal to the number of mobile stations 116 in the group, and each bit in the bitmap 214 may be assigned to one corresponding mobile station 116. The assigned bit indicates whether the corresponding mobile station 116 is in a talk period or in a silence period, for example where a bit value of 1 indicates a talk period and a bit value of 0 indicates a silence period. For example, as shown in bitmap 214 of FIG. 2 for a group of ten mobile stations 116, MS 1, 3, 4, 7, and 9 have been scheduled resources in frame 200. Slots for the scheduled mobile stations 116 are shown by the rectangular allocation 220 for the group of mobile stations 116 showing allocated slots for the corresponding scheduled mobile stations 116. When using bitmap 214, the location of the resources of each mobile station 116 within the resources of the group is not fixed. Instead, each mobile station 116 determines its location based on the number of active, talk period, mobile stations 116 occurring before it in the bitmap 214. Thus, in one or more embodiments, the utilization of one or more bitmaps 214 is capable of providing a mechanism to temporarily switch off the allocation when no transmission is needed thereby reduce waste of resources. However, this is merely one example of using a bitmap 214 for persistent allocation, and the scope of the claimed subject matter is not limited in this respect. In one or more embodiments, such a grouping using bitmap 214 may be utilized for persistent scheduling of HARQ retransmissions as discussed in further detail, below.

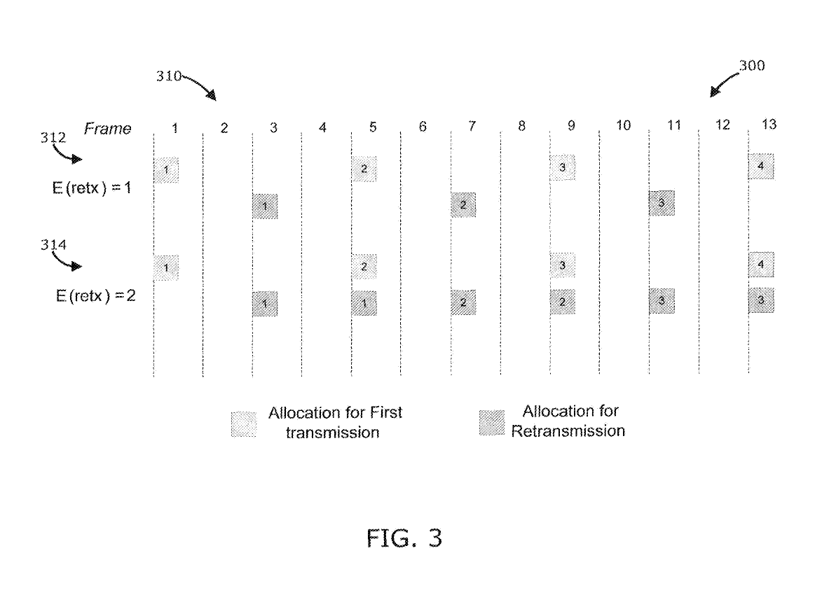

Referring now to FIG. 3, a diagram showing an example of persistent allocation of HARQ retransmissions with respect to first transmissions in accordance with one or more embodiments will be discussed. One example arrangement for allocating retransmissions is shown in diagram 300 of FIG. 3 where the expected number of HARQ retransmissions is one and another example where the expected number of HARQ retransmissions is two. The frame number is indicated by frame slots 310. An example where the expected number of retransmissions is one, E(retx)=1, is shown in the upper portion 312 of diagram 300, and an example where the expected number of retransmissions is two, E(retx)=2, is shown in the lower portion 314 of diagram 300. Although diagram 300 shows examples where the expected number of retransmissions is one or two, any number of expected retransmissions may be implemented, and the scope of the claimed subject matter is not limited in this respect.

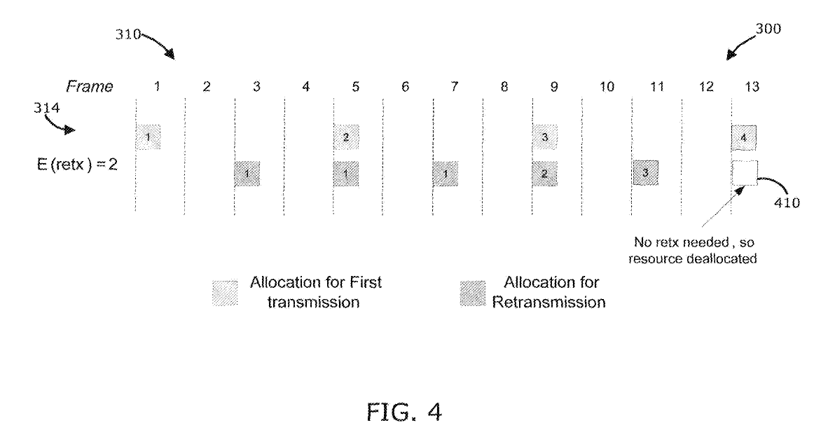

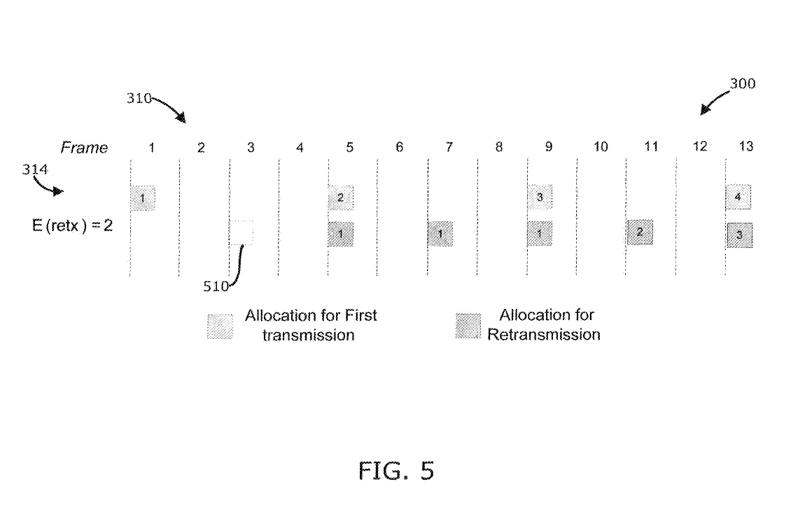

As shown in FIG. 3, where the expected number of retransmissions is one as shown in the upper portion 312 of diagram 300, for MS 1 base station 120 may schedule the transmission of a packet for MS 1 in frame 1 and schedule HARQ retransmission of that packet in frame 3. Likewise, for MS 2 base station 120 may schedule the transmission of a packet for MS 2 in frame 5 and schedule HARQ retransmission of that packet in frame 7. For MS 3 base station 120 may schedule the transmission of packet for MS 3 in frame 9 and schedule HARQ retransmission of that packet in frame 11, and so on. As shown in FIG. 3, where the expected number of retransmissions is two as shown in the lower portion 314 of diagram 300, for MS 1 base station 120 may schedule transmission of a packet for MS 1 in frame 1, schedule a first HARQ retransmission of that packet in frame 3, and schedule a second HARQ retransmission of that packet in frame 5. Since two retransmissions are possible, base station 120 may schedule the second retransmission of the packet for MS 1 in the same frame in which the initial packet transmission for MS 2 is scheduled, which is frame 5 in the example shown in FIG. 3. For MS 2 base station 120 may schedule the transmission of a packet for MS 2 in frame 5, schedule a first HARQ retransmission for that packet in frame 7, and schedule a second HARQ retransmission of that packet in frame 9. Likewise, for MS 3 base station 120 may schedule the initial transmission of a packet for MS 3 in frame 7, schedule the first HARQ retransmission of that packet in frame 11, and schedule the second HARQ retransmission of that packet in frame 13, and so on. It should be noted that although a second or additional HARQ retransmissions may be scheduled by base station 120, the second or additional HARQ retransmission may not be need in the event the first and/or and earlier retransmission is successful. In such a situation, the scheduling arrangement discussed herein may be flexible to accommodate the situation where such second or additional retransmissions are not needed, and other transmissions may occur in those frames where the unneeded retransmissions were otherwise rescheduled. Such flexible scheduling is shown in and described with respect to FIG. 4 and FIG. 5, below.

In one or more embodiments, in order to persistently schedule retransmission using grouping, one or more transmissions may be persistently scheduled but may be intermittently switched off using the bitmap 214. For example, if the corresponding bit in the bitmap 214 is set to 0, no resource will be allocated for that transmission. In one or more embodiments, a given mobile station 116 may be allocated to a group twice, once for a first transmission and once for retransmissions. The allocation for the first transmission may be implemented via the bitmap 214 as shown in and described with respect to FIG. 2, above. The mobile station 116 is allocated with a period of p_{f} frames. The corresponding bit in the bitmap 214 indicates whether there is any packet for the mobile station 116 or not in that frame. For HARQ retransmissions, the mobile station 116 is allocated another position in the bitmap 214. This other allocated position may either be the same bitmap 214 as the one for first transmissions, or another separate bitmap per group may be utilized for retransmissions. The period of allocation for retransmissions, pᵣ, may be the same as or different from p_{f} depending on how many retransmissions are expected per packet. For example, if the expected number of retransmissions per packet is 2, then pᵣ can be p_{f}/2.

The number of retransmissions needed for a given packet may depend on instantaneous channel conditions and may be variable. However, the expected number of retransmissions is the average number of retransmissions needed over time, and may be a function of the initial target packet error rate (PER) that is used to select MCS. If the target PER is relatively high, an aggressive MCS is chosen compared to the channel conditions. Hence the expected number of retransmissions also will be relatively high. On the other hand, if the target PER is low, a conservative MCS is chosen and a fewer number of retransmissions would be expected. Thus, in one or more embodiments, two ways of determining the period of allocation for retransmissions may be utilized. In one embodiment, the period of allocation may be a configurable parameter in the base station 120 and may be configured based at least in part on the target PER and/or the past experience of how many average retransmissions are required to achieve that target PER to arrive at an expected number of retransmissions. In an alternative embodiment, the base station 120 may implement a smart algorithm in which base station 120 may adaptively learn the average number of retransmissions required over a given period of time to arrive at an expected number of retransmissions. Once the expected number of retransmissions is known, the base station 120 can allocate mobile stations 120 for retransmissions with a period based at least in part on the expected number of retransmissions. Example ways of allocating retransmissions that consider the expected number of transmissions as one expected retransmission and two expected retransmissions, respectively, are discussed in further detail with respect to FIG. 4 and FIG. 5, below.

Although the retransmissions are shown in FIG. 3 as belonging to specific packets, this is not necessary and may be flexible wherein the allocations can be given to any packet depending on how many retransmissions are needed for each packet. Which packet the retransmissions belongs to may be identified by a 4-bit ARQ channel identifier (ACID) number, which may be a part of the bitmap 214 itself or may occur somewhere else in the MAP or may be decided through out-of-band signaling. The format of bitmap 214 where ACID is part of the bitmap is shown in Table 1, below.

TABLE 1
Bitmap format including ACID (HARQ Channel Identifier)

| | |
|---|---|
| For Each Subburst (User) | |
| Sched Indicator (SI) | 1 |
| If (SI = = 1) { | |
| ACID | 4 |
| } | |

Thus, although the actual number of retransmissions may vary from packet to packet, the allocations provided based at least in part on an expected number of retransmissions may be sufficient to accommodate all or nearly all retransmissions over a period of time, and the scope of the claimed subject matter is not limited in this respect.

Referring now FIG. 4 and FIG. 5, diagrams showing example uses of allocated resources for different packets where the ACK delay is less than two frames as shown in FIG. 4, or where the ACK delay is less than four frames as shown in FIG. 5, in accordance with one or more embodiments will be discussed. In one or more embodiments, some allocations for retransmissions may not be required since there may be no retransmissions to send, for example if an earlier transmission or retransmission is successful. In such an event, the resource in the frame may be deallocated by base station 120 simply by setting the corresponding bit in the bitmap 214 to 0 for the corresponding mobile station 116 who no longer needs one or more rescheduled retransmissions. Such an example resource deallocation and/or reallocation scenario is shown in FIG. 4. Diagram 300 illustrates the case where the acknowledgment (ACK) delay is less than two frames. In diagram 300 of FIG. 4, the expected number of retransmissions is two, therefore a scheduled packet to be transmitted will also have two corresponding retransmissions scheduled. In one embodiment, for MS 3 base station 120 may schedule initial transmission of a packet for MS 3 in frame 9, schedule a first transmission of that packet in frame 11, and schedule a second retransmission of that packet in frame 13. In the event that the second retransmission is no longer needed, for example if the retransmission of the packet in frame 11 is successful, then base station 120 may deallocate the second retransmission of the packet for MS 3, at slot 410, and may reallocate slot 410 to another mobile station 116 other than MS 3 by setting the bit value to 0 for MS 3 for slot 410. Likewise, if the ACK delay is more than two frames, then the retransmissions of packets will shift towards the right, that is be delayed in time, as shown for example in FIG. 5. In FIG. 5, if the ACK delay is four frames rather than two frames, the allocation of a first retransmission of a packet for MS 1 may be shifted from frame 3 to frame 5, and packet transmissions and/or retransmissions may be scheduled for a corresponding shifted number of frames as shown in FIG. 5. Optionally, base station 120 may reallocate slot 510 for another use other than for the originally scheduled first retransmission of the packet for MS 1. However, the dynamic allocation, deallocation, and/or reallocation of resources as shown in FIG. 4 and FIG. 5 are merely examples, and the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining to persistent scheduling of HARQ retransmissions and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A method, comprising:
scheduling the transmission of one or more packets to be downloaded to one or more users; and
scheduling one or more retransmissions of the one or more packets, wherein the scheduling of the one or more retransmissions remains persistent for at least one or more subsequent frames without requiring scheduling of the one or more retransmissions in one or more of the subsequent frames.

2. A method as claimed in claim 1, wherein the one or more retransmissions comprise hybrid automatic repeat-request type retransmissions.

3. A method as claimed in claim 1, said scheduling the transmission of one or more packets to be downloaded or said scheduling of one or more retransmissions, or combinations thereof, comprising grouping the one or more users using a bitmap to indicate whether the user is scheduled to receive a transmission in a given frame.

4. A method as claimed in claim 1, said scheduling the transmission of one or more packets to be downloaded or said scheduling of one or more retransmissions, or combinations thereof, comprising grouping the one or more users using a bitmap to indicate whether the user is scheduled to receive a transmission in a given frame, the bitmap for said scheduling of one or more retransmissions being the same, or nearly the same, as the bitmap for said scheduling the transmission of one or more packets to be downloaded.

5. A method as claimed in claim 1, said scheduling the transmission of one or more packets to be downloaded or said scheduling of one or more retransmissions, or combinations thereof, comprising grouping the one or more users using a bitmap to indicate whether the user is scheduled to receive a transmission in a given frame, the bitmap for said scheduling of one or more retransmissions being a different bitmap from the bitmap for said scheduling the transmission of one or more packets to be downloaded.

6. A method as claimed in claim 1, said scheduling one or more retransmissions of the one or more packets comprising scheduling an expected number of retransmissions based at least in part on a target packet error rate.

7. A method as claimed in claim 1, further comprising updating said scheduling one or more retransmissions of the one or more packets if one or more of the scheduled retransmissions is not needed including reallocating a slot for a scheduled retransmission that is not needed.

8. A method as claimed in claim 1, further comprising shifting said scheduling one or more retransmissions of the one or more packets by one or more frames based at least in part on an acknowledgment delay.

9. A base station, comprising:
a radio-frequency circuit capable of transmitting packets to one or more users via a radio-frequency communication; and
a baseband processor coupled to said radio-frequency circuit, said baseband processor being configured to:
schedule the transmission of one or more packets to be downloaded to one or more users; and
schedule one or more retransmissions of the one or more packets, wherein the scheduling of the one or more retransmissions remains persistent for at least one or more subsequent frames without requiring scheduling of the one or more retransmissions in one or more of the subsequent frames.

10. A base station as claimed in claim 9, said baseband processor being further configured to schedule the transmission of one or more packets to be downloaded or to schedule one or more retransmissions, or combinations thereof, by grouping the one or more users using a bitmap to indicate whether the user is scheduled to receive a transmission in a given frame.

11. A base station as claimed in claim 9, said baseband processor being further configured to schedule the transmission of one or more packets to be downloaded or to schedule one or more retransmissions, or combinations thereof, by grouping the one or more users using a bitmap to indicate whether the user is scheduled to receive a transmission in a given frame, the bitmap used to schedule one or more retransmissions being the same, or nearly the same, as the bitmap used to schedule the transmission of one or more packets to be downloaded.

12. A base station as claimed in claim 9, said baseband processor being further configured to schedule the transmission of one or more packets to be downloaded or to schedule one or more retransmissions, or combinations thereof, by grouping the one or more users using a bitmap to indicate whether the user is scheduled to receive a transmission in a given frame, the bitmap used to schedule one or more retransmissions being a different bitmap from the bitmap used to schedule the transmission of one or more packets to be downloaded.

13. A base station as claimed in claim 9, said baseband processor being further configured to schedule an expected number of retransmissions based at least in part on a target packet error rate.

14. A base station as claimed in claim 9, said baseband processor being further configured to update a schedule of one or more retransmissions of the one or more packets if one or more of the scheduled retransmissions is not needed including reallocating a slot for a scheduled retransmission that is not needed.

15. A base station as claimed in claim 9, said baseband processor being further configured to shift a schedule of one or more retransmissions of the one or more packets by one or more frames based at least in part on an acknowledgment delay.
